(19) United States
(12) Patent Application Publication
(10) Pub. No.: US 2004/0080377 A1
(43) Pub. Date: Apr. 29, 2004

(54) Waveguide structured package and method for fabricating the same

(76) Inventors: Woo Jin Chang, Seo-Gu (KR); Hyung Sup Yoon, Yuseong-Gu (KR); Hea Cheon Kim, Yuseong-Gu (KR); Kyoung Ik Cho, Yuseong-Gu (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/690,299

(22) Filed: Oct. 20, 2003

(30) Foreign Application Priority Data
Oct. 21, 2002 (KR) 2002-64135

(51) Int. Cl. H01P 5/103

(52) U.S. Cl. 333/26; 333/247

(57) ABSTRACT

The present invention relates to a waveguide structured package and a method of manufacturing the same. More particularly, there are provided a waveguide structured package capable of preventing generation of parasitic components due to bonding wires and reducing the processing time to reduce the production cost of the waveguide structured package by providing a probe, a microstrip-waveguide transition portion and a microstrip line within a semiconductor chip and thus making bonding wire unnecessary in manufacturing the waveguide structured package, and a method of manufacturing the waveguide structured package.

### BACKGROUND OF THE INVENTION

1. Field of the Invention

The present invention relates to a waveguide structured package and a method of manufacturing the same. More particularly, the present invention relates to a waveguide structured package capable of reducing a processing time to reduce production cost, and preventing input/output matching and performance thereof from deteriorating, and a method of manufacturing the waveguide structured package.

2. Description of the Prior Art

Generally, a waveguide structured package used in the ultra high frequency band is shown in FIGS. 1A and 1B. FIG. 1A is a plan view of a conventional waveguide structured package, and FIG. 1B is a cross-sectional view of the waveguide structured package taken along a line I-I′ in FIG. 1A. Here, FIG. 1A is a plan view showing only a lower end housing, where an upper end housing is not shown.

Referring to the FIGS. 1A and 1B, the conventional waveguide structured package has a structure that the lower end housing 100 and the upper end housing 200 which are provided with waveguides 110a, 110b are combined with each other. A semiconductor chip 130 is attached to the lower end housing 100 by means of an adhesive 120b, and PCBs (Printed Circuit Board) 140, 150 are attached respectively on both sides of the semiconductor chip 130 by means of adhesives 120a, 120c. The semiconductor chip 130 and the PCBs 140, 150 are separated from each other. In addition, the semiconductor chip 130 and the PCBs 140, 150 are connected to each other by means of bonding wires 160a, 160b. On the other hand, the upper end housing 200 is coupled to the lower end housing 100, to serve as a cover for protecting the semiconductor chip 130 and the PCBs 140, 150 attached to the lower end housing 100.

Flow of a RF signal in the conventional waveguide structured package mentioned above is as follows.

First, the RF signal is input to the waveguide 110a disposed on a left side in the lower end housing 100. The input RF signal is transmitted to a probe 140a disposed in the PCB 140, and then transmitted to a microstrip line 140c via a microstrip-waveguide transition portion 140b. Next, the RF signal is input through the bonding wire 160a to an input pad 130a disposed in the semiconductor chip 130, and the input RF signal is output to the bonding wire 160b to an output pad 130e through the main circuitry (not shown) within the semiconductor chip 130. Next, sequentially via the bonding wire 160b, a microstrip line 150c, a microstrip-waveguide transition portion 150b and a probe 150a disposed in the PCB 150, the RF signal is outputted through the waveguide 110b disposed on a right side in the lower end housing 100.

However, an input/output matching of the semiconductor chip 130 is deteriorated by parasitic components due to the bonding wires 160a, 160b connecting the semiconductor chip 130 and the PCBs 140, 150, whereby performance of the elements after manufacturing the waveguide structured package deteriorates. Furthermore, since lengths of the bonding wires 160a, 160b can be slightly varied in the course of manufacturing the waveguide structured package, it is difficult to predict the parasitic components thereof, thereby causing the decrease of production yield thereof to increase production cost.

### SUMMARY OF THE INVENTION

The present invention is therefore contrived to solve the above problems. It is object of the present invention to provide a waveguide structured package capable of reducing the processing time to reduce the production cost.

It is another object of the present invention to improve an input/output matching and performance of a semiconductor chip.

It is still another object of the present invention to increase a production yield of a waveguide structured package to reduce the production cost.

It is still another object of the present invention to decrease size of a waveguide structured package to reduce the production cost.

According to an aspect of the present invention, there is provided a waveguide structured package, comprising: an upper end housing; and a lower end housing including waveguides which a RF signal is input to and output from and a semiconductor chip mounted on a top of a central portion disposed between the waveguides, wherein the semiconductor chip includes an input strip portion and an output strip portion for propagating the RF signal via the waveguides, and wherein the upper end housing and the lower end housing are coupled correspondingly to each other.

According to another aspect of the present invention, there is provided a method of manufacturing a waveguide structured package, comprising: (a) a step of forming an upper end housing having at least two grooves at a part thereof, (b) a step of forming a lower end housing by forming the waveguides correspondingly to the grooves and mounting a semiconductor chip on a top of a central portion between the waveguides, the semiconductor chip comprising an input strip portion and an output strip portion for transmitting RF signal input and output through the waveguides; and (c) a step of coupling the upper end housing and the lower end housing correspondingly to each other.

### BRIEF DESCRIPTION OF THE DRAWINGS

The aforementioned aspects and other features of the present invention will be explained in the following description, taken in conjunction with the accompanying drawings, wherein:

FIG. 1A is a plan view of a conventional waveguide structured package,

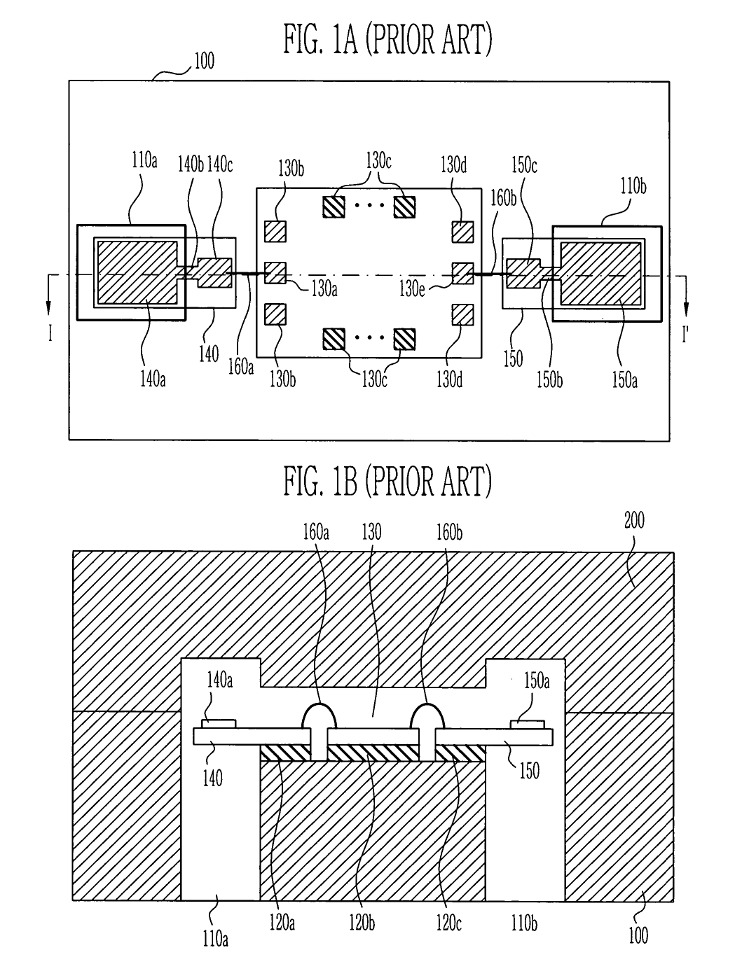

FIG. 1B is a cross-sectional view of the waveguide structured package taken along a line I-I′ shown in FIG. 1A,

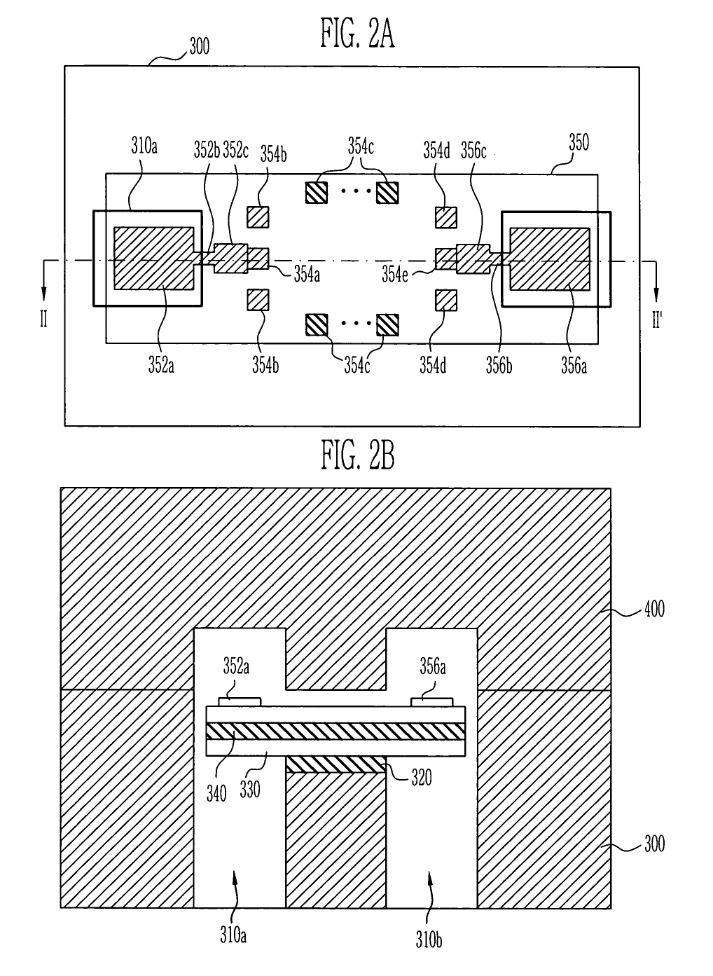

FIG. 2A is a plan view of a waveguide structured package according to a preferred embodiment of the present invention,

FIG. 2B is a cross-sectional view of the waveguide structured package taken along a line II-II′ shown in FIG. 2A,

FIG. 3 is a plan view of a semiconductor chip shown in FIG. 2A and FIG. 2B, and

FIGS. 4 to 9 are cross-sectional views for illustrating a method of manufacturing the waveguide structured package shown in FIGS. 2A and 2B.

### DETAILED DESCRIPTION OF PREFERRED EMBODIMENTS

Now, the preferred embodiments according to the present invention will be described in detail with reference to the appended drawings. However, the present invention is not limited to the preferred embodiments disclosed in the following description, but can be implemented with various changes and modifications. Thus, these embodiments according to the invention are for informing those skilled in the art of the scope of the present invention.

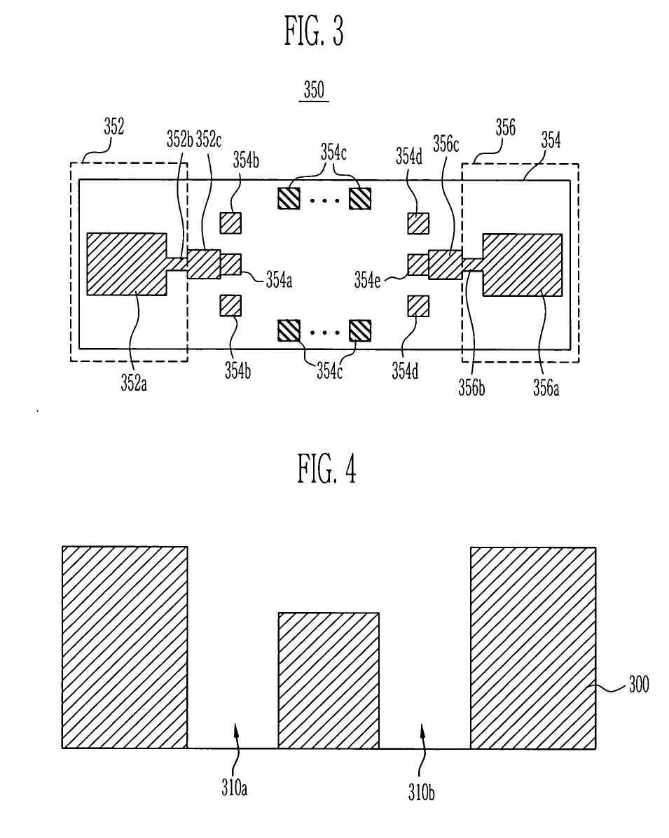

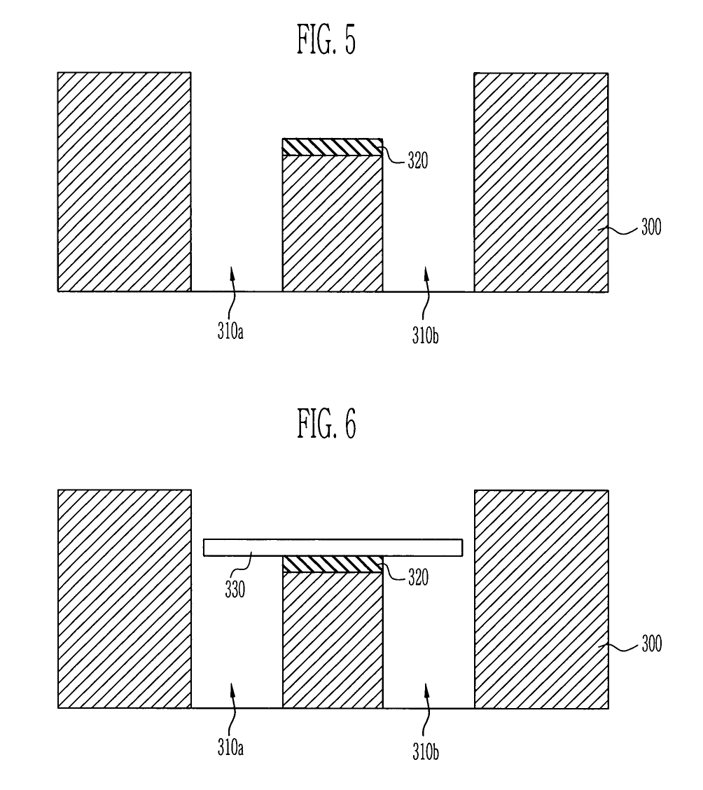

FIG. 2A is a plan view of the waveguide structured package according to a preferred embodiment of the present invention, and FIG. 2B is a cross-sectional view of the waveguide structured package taken along a line II-II′ in FIG. 2A. Here, FIG. 2A is a plan view showing only the lower end housing, with the upper end housing not shown.

Referring to the FIGS. 2A and 2B, the waveguide structured package according to a preferred embodiment of the present invention has a structure that a lower end housing 300 and an upper end housing 400 are coupled correspondingly to each other.

Waveguides 310a, 310b through which a RF signal is input and output are disposed in the lower end housing 300. In addition, a semiconductor chip 350 is mounted on a top of a central portion located between the waveguides 310a, 310b in the lower end housing 300. In addition, a dummy PCB 330 is disposed between the semiconductor chip 350 and the lower end housing 300 to prevent the semiconductor chip 350 and the lower end housing 300 from cracking due to external impact. In addition, the bottom of the dummy PCB 330 is attached to the top of the central portion of the lower end housing 300 by means of an adhesive 320, and the top of the dummy PCB 330 is attached to the bottom of the semiconductor chip 350 by means of an adhesive 340. On the other hand, a plurality of via holes for connecting the lower end housing 300 to a ground terminal of the semiconductor chip 350 is formed in predetermined portions of the dummy PCB 330.

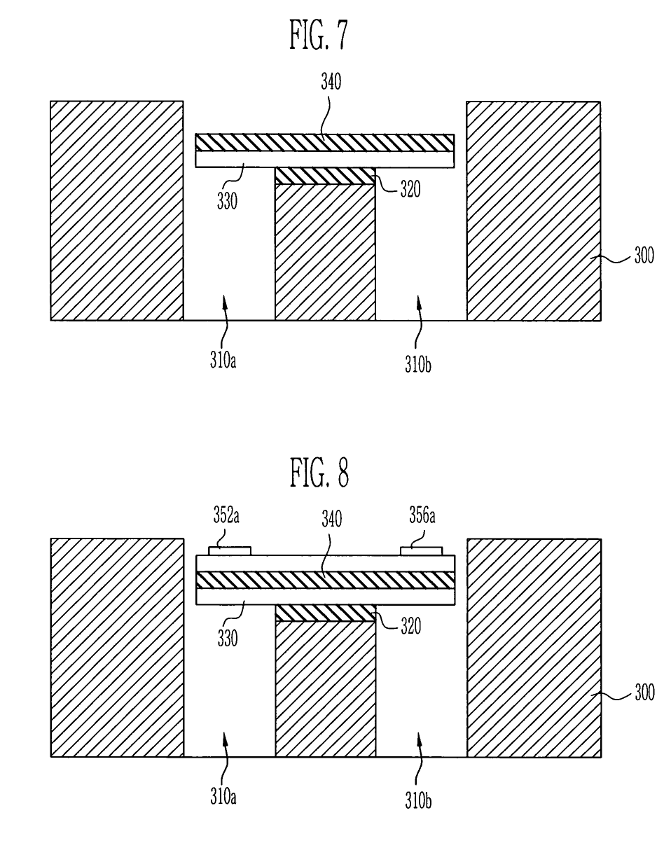

As shown in FIG. 3, the semiconductor chip 350 comprises an input microstrip portion (hereinafter referred to as “input strip portion”) 352, a main circuit portion 354 and an output microstrip portion (hereinafter, referred to as “output strip portion”) 356. The input strip portion 352 comprises a probe 352a, a microstrip-waveguide transition portion 352b and a microstrip line 352c. The output strip portion 356 comprises a probe 356a, a microstrip-waveguide transition portion 356b and a microstrip line 356c, similar to the input strip portion 352. The main circuit portion 354 comprises an input pad 354a for receiving the RF signal transmitted from the input strip portion 352, ground pads 354b, 354d for RF grounding, DC bias pads 354c for operating the semiconductor chip 350, and an output pad 354e. In addition, the main circuit portion 354 further comprises predetermined circuits (not shown). The predetermined circuits may be variously designed depending on the uses and design methods of the semiconductor chip. Here, the input pad 354a and the ground pads 354b or the output pad 354e and the ground pads 354d are made to have a GSG (Ground Signal Ground) structure, and are fabricated as the pads having the GSG structure for use common to a DC ground in fabricating the semiconductor chip 350.

Flow of the RF signal in the waveguide structured package according to the preferred embodiments of the present invention is as follows.

First, the RF signal is inputted to the waveguide 310a disposed on the left side in the lower end housing 300. The input RF signal is transmitted to the probe 352a of the input strip portion 352 disposed within the semiconductor chip 350, and then transmitted to the microstrip line 352c via the microstrip-waveguide transition portion 352b. Next, the RF signal is input to the input pad 354a of the main circuit portion 354 disposed within the semiconductor chip 350, and the input RF signal is output to the output strip portion 356 disposed within the semiconductor chip 350 via the circuits. Next, sequentially passing through the microstrip line 356c, the microstrip-waveguide transition portion 356b and the probe 356a of the output strip portion 356, the RF signal is output externally through the waveguide 310b disposed on the right side thereof.

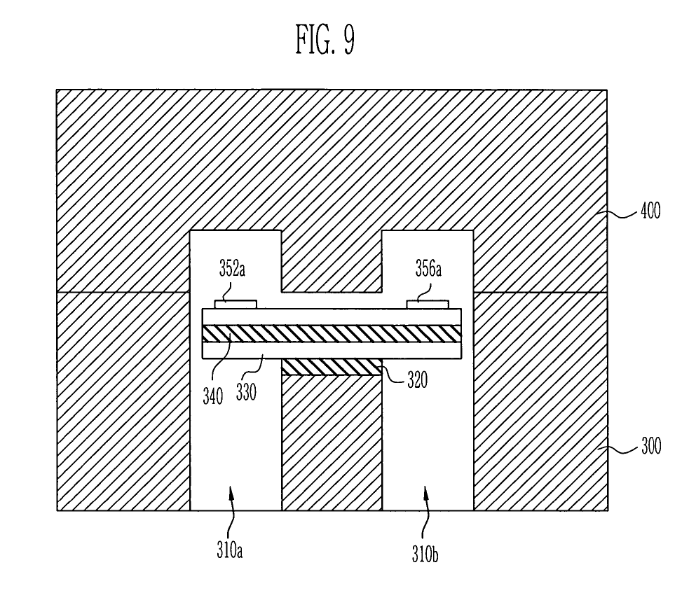

A method of manufacturing the waveguide structured package according to the preferred embodiment of the present invention described above will be described with reference to FIGS. 4 to 9. In FIGS. 4 to 9, substantially the same members having the same functions as in FIGS. 2A, 2B and 3 are denoted by the same reference numerals.

Referring to FIG. 4, the lower end housing 300 provided with the waveguides 310a, 310b is prepared. At this time, the lower end housing 300 is made of conductive metal to ground ground pads 354b, 354d of the semiconductor chip (see a reference numeral “350” in FIG. 2). On the other hand, the waveguides 310a, 310 are passages through which a RF signal is input and output, and have a rectangular shape. The sizes of the waveguides 310a, 310 are determined depending on a frequency of the RF signal. For example, the higher the frequency becomes the lower the size becomes.

Referring to FIG. 5, the adhesive 320 is applied to the top of the central portion of the lower end housing 300 disposed between the waveguides 310a, 310b. As the adhesive 320, it is preferable to use an adhesive material having a relatively lower melting point in order to be attached by heating. For example, any one of Ag epoxy, AnSn, BiSn, silver brazing and glass brazing may be appropriately selected.

Referring to FIG. 6, the dummy PCB 330 is attached to the top of the adhesive 320. The dummy PCB 330 serves to prevent the semiconductor chip 350 or the lower end housing 300 from being cracked due to collision of the semiconductor chip 350 and the lower end housing 300 by external impacts. In another words, the dummy PCB 330 serves to dampen the collision of the semiconductor chip 350 and the lower end housing 300. On the other hand, a plurality of via holes, penetrating the dummy PCB 330 from the top to the bottom thereof are provided in the predetermined portions of the dummy PCB 330. For example, the portions corresponding to the ground pads 354b, 354d of the semiconductor chip 350 or arbitrary portions of the back surface of the semiconductor chip 350 when the semiconductor chip 350 has been subjected to a back-surface grounding process, the back-surface of the semiconductor chip is a ground surface in order to ground the semiconductor chip 350 using the lower end housing 300.

Referring to FIG. 7, the adhesive 340 is applied to the top of the dummy PCB 330. The adhesive 340 is the same as the adhesive 320 disposed on top of the central portion of the lower end housing 300. For example, any one of Ag epoxy, AuSn, BiSn, silver brazing and glass brazing is appropriately selected.

Referring to FIG. 8, the semiconductor chip 350 is attached to the dummy PCB 330 using the adhesive 340 by heating the adhesive after disposing the semiconductor chip 350 on the adhesive 340. The input strip portion 352, the main circuit portion 354 and the output strip portion 356 are provided in the semiconductor chip 350, as shown in FIG. 3. At this time, the microstrip line 352c of the input strip portion 352, the input pad 354a of the main circuit portion 354 or the microstrip line 356c of the output strip portion 356 and the output pad 354e of the main circuit portion 354 are electrically connected to each other to transmit the RF signals.

Referring to FIG. 9, the waveguide structured package is completed by coupling the lower end housing 300 and the upper end housing 400 made of the same conductive metal as the lower end housing 300 correspondingly to each other. At this time, the lower end housing 300 and the upper end housing 400 are coupled using a predetermined adhesive material or attachment members such as a screw. On the other hand, grooves (not shown) having the same size as the waveguides 310a, 310b are formed in portions of the upper end housing 400 corresponding to the waveguides 310a, 310b of the lower end housing 300.

Although the technical spirit of the present invention has been specifically described in the preferred embodiments, it should be noted that the preferred embodiments are only for exemplifying the present invention, but not for limiting the present invention. Furthermore, the skilled in the art can understand that various changes and modifications of the present invention may be made without departing from the technical spirit and the scope of the present invention.

As described above, according to the present invention, it is possible to prevent parasitic components due to the bonding wires from being generated since bonding wire is not required for manufacturing the waveguide structured package by providing the probe, the microstrip-waveguide transition portion, and the microstrip line in the semiconductor chip.

Furthermore, it is possible to eliminate the conventional process for forming bonding wires, since bonding wire is not required. Therefore, it is possible to reduce the time for manufacturing the waveguide structured package and the production cast.

Furthermore, it is possible to prevent the input/output matching and the performance of the semiconductor chip from being deteriorated due to the parasitic components of the bonding wires caused essentially in the conventional art, by eliminating the bonding wires. That is, it is possible to maintain the independent input/output matching and the performance of the semiconductor chip by eliminating the bonding wires.

Furthermore, it is possible to reduce the length of the microstrip line which the bonding wires occupy and thus to reduce the size of the waveguide structured package since the present invention does not require the PCB provided essentially with the probe, the microstrip-waveguide transition portion and the microstrip line indispensable in the conventional art. Accordingly, it is possible to realize a light weight, a cost down and increase of production yield.

Furthermore, by forming the microstrip-waveguide transition portion in the semiconductor chip, it is possible to more precisely form the microstrip-waveguide transition than through the process of the conventional art in which the microstrip-waveguide transition portion is patterned in the PCB.

What is claimed is:

1. A waveguide structured package, comprising:
an upper end housing;
a lower end housing including waveguides which a RF signal is input to and output from;
a semiconductor chip disposed between the waveguides,
wherein the semiconductor chip includes an input strip portion and an output strip portion for propagating the RF signal via the waveguides, and
wherein the upper end housing and the lower end housing are coupled to each other.

2. A waveguide structured package according to claim 1, further comprising a dummy PCB disposed between the semiconductor chip and the lower end housing.

3. A waveguide structured package according to claim 2, wherein a top of the dummy PCB is attached to the semiconductor chip, and a bottom of the dummy PCB is attached to the lower end housing.

4. A waveguide structured package according to claim 2, wherein the dummy PCB comprises a plurality of via holes.

5. A waveguide structured package according to claim 1, wherein the input strip portion comprises:
a probe for receiving the RF signal via the waveguides;
a microstrip-waveguide transition portion through which the RF signals received by the probe is transmitted; and
a microstrip line for outputting the RF signal transmitted through the microstrip-waveguide transition portion to an input pad of a main circuit portion provided within the semiconductor chip.

6. A waveguide structured package according to claim 5, wherein the microstrip line and the input pad are electrically connected to each other.

7. A waveguide structured package according to claim 1, wherein the output strip portion comprises:
a probe for receiving the RF signal from an output pad of a main circuit portion provided within the semiconductor chip;
a microstrip-waveguide transition portion through which the RF signals received by the probe is transmitted; and
a microstrip line for outputting the RF signal transmitted through the microstrip-waveguide transition portion to its exterior via the waveguides.

8. A waveguide structured package according to claim 7, wherein the probe and the output pad are electrically connected to each other.

9. A method of manufacturing a waveguide structured package, comprising;
(a) forming an upper end housing having at least two grooves at a part thereof;
(b) forming a lower end housing by forming the waveguides correspondingly to the grooves and mounting a semiconductor chip between the waveguides, the semiconductor chip comprising an input strip portion and an output strip portion for transmitting RF signal input and output through the waveguides; and
(c) coupling the upper end housing and the lower end housing correspondingly to each other.

10. A waveguide structured package according to claim 9, wherein a dummy PCB is attached between the semiconductor chip and the lower end housing using an adhesive.
